(19) United States
(12) Patent Application Publication
(10) Pub. No.: US 2025/0377943 A1
(43) Pub. Date: Dec. 11, 2025

(54) TASK SCHEDULING METHOD FOR MULTI-EDGE DEVICE ASSISTED EDGE COMPUTING NETWORK

(71) Applicant: Zhejiang University of Technology, HANGZHOU (CN)

(72) Inventors: KECHEN ZHENG, HANGZHOU (CN); QIPENG YE, HANGZHOU (CN); XIAOYING LIU, HANGZHOU (CN); KAIKAI CHI, HANGZHOU (CN)

(21) Appl. No.: 19/028,737

(22) Filed: Jan. 17, 2025

(30) Foreign Application Priority Data
Jun. 5, 2024 (CN) 202410721921.0

(51) Int. Cl. G06F 9/50; G06F 9/48

(52) U.S. Cl. CPC G06F 9/5027; G06F 9/4881; G06F 2209/509

(57) ABSTRACT

A task scheduling method for a multi-edge device assisted edge computing network, includes: step 1: acquiring the workloads of computation tasks to be processed by the wireless devices, the transmission rates between the wireless devices and edge devices and the computation rates of the edge devices, and initializing a scheduling policy S as an empty array; step 2: successively deciding offloading selections of the wireless devices according to the serial numbers of the wireless devices, and inserting the offloading selections into appropriate inserting positions in the scheduling policy S; and, step 3: offloading the computation tasks, according to the final scheduling policy S and by the wireless devices, to the designated edge devices for computation. The present invention is suitable for, in a time division multiple access (TDMA) communication mode and a binary offloading mode.

### TECHNICAL FIELD OF THE INVENTION

The present invention belongs to the technical field of edge computing, and relates to a task scheduling method for a multi-edge device assisted edge computing network.

### BACKGROUND OF THE INVENTION

With the rapid development of the Internet of Things (IoT), numerous applications with computation-intensive and delay-sensitive computation tasks, such as mobile online gaming and face recognition, have emerged for entertainment and social interactions. Limited by the size and price, traditional wireless devices (WDs) in the IoT are generally computation-constrained and energy-constrained, making it challenging for them to timely process such computation tasks.

The mobile edge computing (MEC) technology can solve the above problem well. This technology deploys rich computation resources on edge devices (EDs) at the edge of the network to compute the computation tasks of wireless devices. Compared with an edge computing network with a single edge device deployed at the edge of the network, the edge computing network with multiple edge devices deployed at the edge of the network can accelerate task computation, and thus has a promising application prospect. However, at present, how to optimize the offloading selections of wireless devices, i.e., choosing edge devices to compute the computation tasks, and the scheduling order of task offloading in the multi-edge device assisted edge computing network to realize a smaller maximum task completion time of wireless devices has not been deeply studied.

### SUMMARY OF THE INVENTION

In order to overcome the deficiencies of the existing technologies, the present invention provides a task scheduling method for a multi-edge device assisted edge computing network, which is suitable for, in a time division multiple access (TDMA) communication mode and a binary offloading mode, deciding the offloading selections of wireless devices and the scheduling order of task offloading of corresponding computation tasks according to the workloads of computation tasks to be processed by the wireless devices, the transmission rates between wireless devices and edge devices and the computation rates of the edge devices, to realize a smaller maximum task completion time of the wireless devices.

The present invention employs the following technical solutions to solve the technical problem:

A task scheduling method for a multi-edge device assisted edge computing network is provided. The multi-edge device assisted edge computing network includes M edge devices and N wireless devices, wherein the edge devices are connected to the wireless devices through wireless links, and the edge devices can provide computing services for the wireless devices; and every wireless device owns an indivisible computation task to be processed, does not have enough computational capacity to process it locally, and has to offload it to one of the edge devices for computation in a time division multiple access manner. Every edge device can compute the computation task only after it has received the whole computation task. Every edge device is allowed to receive one computation task and compute another computation task simultaneously, every edge device can only compute at most one computation task at any time, and different edge devices can compute their respectively received computation tasks simultaneously. In order to realize a smaller maximum task completion time, the wireless devices continuously offload tasks to the edge devices in a time division multiple access manner until all the wireless devices have offloaded computation tasks, and the edge devices can stop the computation operation only when there are no received computation tasks can be computed. The task scheduling method for an edge computing network includes the following steps:
step 1: acquiring the workloads of computation tasks to be processed by the wireless devices, the transmission rates between the wireless devices and the edge devices and the computation rates of the edge devices, and initializing a scheduling policy S as an empty array;
step 2: successively deciding the offloading selections of the wireless devices according to the serial numbers of the wireless devices, and inserting the offloading selections into appropriate inserting positions in the scheduling policy S; and
step 3: offloading the computation tasks, according to the final scheduling policy S and by the wireless devices, to the designated edge devices for computation in sequence, to minimize the maximum task completion time of the wireless devices.

Further, in step 2, the scheduling policy S=[ . . . , [i, j], . . . ] contains the offloading selections of the wireless devices and the scheduling order of task offloading of corresponding computation tasks, where the offloading selection [i, j] of the wireless device represents that the i^{th} wireless device offloads the computation task to the j^{th} edge device for computation, and the order of the offloading selections of the wireless devices in the scheduling policy S represents the scheduling order of task offloading of corresponding computation tasks.

Furthermore, in step 2, in order to decide the offloading selection of the i^{th} wireless device, the transmission delays of the i^{th} wireless device offloading the computation task to different edge devices and the computation delays of different edge devices computing the received computation task of the i^{th} wireless device are calculated according to the information obtained in step 1. Without changing the relative positions of the existing offloading selections in the scheduling policy S, i candidate scheduling policies S are generated for every candidate offloading selection of the i^{th} wireless device, and the corresponding maximum task completion times are calculated. As the number of candidate offloading selections of i^{th} wireless device is M, Mi candidate scheduling policies S are generated in total for the i^{th} wireless device, and the candidate scheduling policy S with the smallest maximum task completion time is selected and updated as the new scheduling policy S.

The transmission delay of the i^{th} wireless device offloading the computation task to the j^{th} edge device is:

$${t}_{i , j} = \frac{{w}_{i}}{{r}_{i , j}}$$

where wᵢ is the workload of the computation task of the i^{th} wireless device, and r_{i,j} is the transmission rate between the i^{th} wireless device and the j^{th} edge device.

The computation delay of the j^{th} edge device computing the received computation task of the i^{th} wireless device is:

$${c}_{i , j} = \frac{{w}_{i}}{{f}_{j}}$$

where fⱼ is the computation rate of the j^{th} edge device.

The beneficial effects of the present invention are mainly manifested as follows: the present invention solves the task scheduling problem of the multi-edge device assisted edge computing network, including the offloading selections of the wireless devices and the scheduling order of task offloading of corresponding computation tasks, to realize a small maximum task completion time of the wireless devices.

### BRIEF DESCRIPTION OF THE DRAWINGS

FIG. 1 is a system scenario diagram of a task scheduling method for a multi-edge device assisted edge computing network;

FIG. 2 is an example diagram of the maximum task completion time under different scheduling policies of a task scheduling method for a multi-edge device assisted edge computing network;

FIG. 3 is a flowchart of a task scheduling method for a multi-edge device assisted edge computing network; and

FIG. 4 is an example diagram of a specific implementation of a task scheduling method for a multi-edge device assisted edge computing network.

### DETAILED DESCRIPTION OF THE INVENTION

The present invention will be further described below with reference to the accompanying drawings.

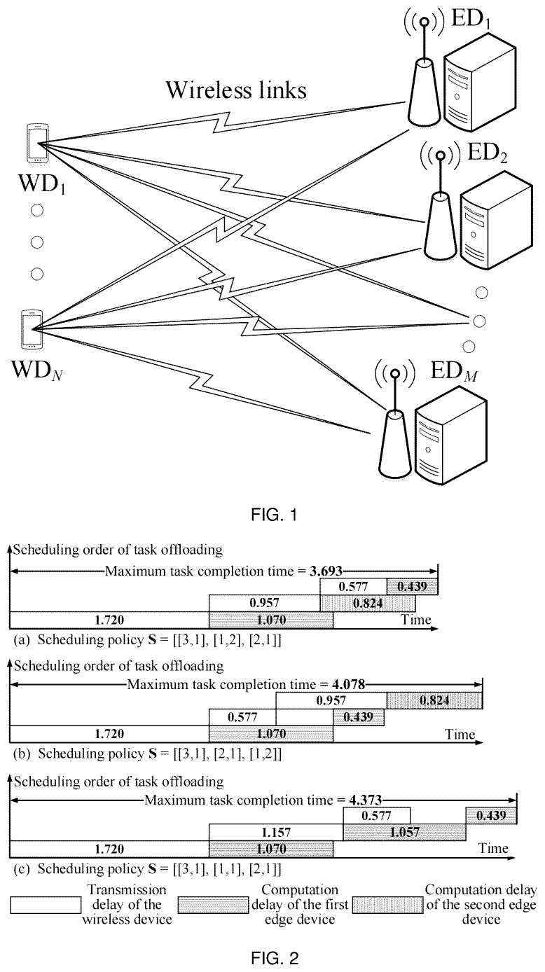

With reference to FIGS. 1-4, a task scheduling method for a multi-edge device assisted edge computing network is provided. As shown in FIG. 1, the multi-edge device assisted edge computing network includes M edge devices and N wireless devices, wherein the edge devices are connected to the wireless devices through wireless links, and the edge devices can provide computing services for the wireless devices. Every wireless device owns an indivisible computation task to be processed, does not have enough computational capacity to process it locally, and has to offload it to one of the edge devices for computation in a time division multiple access manner. As shown in FIG. 2, every edge device can compute the computation task only after it has received the whole computation task. Every edge device is allowed to receive one computation task and compute another computation task simultaneously, every edge device can only compute at most one computation task at any time, and different edge devices can compute their respectively received computation tasks simultaneously. In order to realize a smaller maximum task completion time, the wireless devices continuously offload computation tasks to the edge devices in a time division multiple access manner until all the wireless devices have offloaded computation tasks, and the edge devices can stop the computation operation only when there are no received computation tasks can be computed.

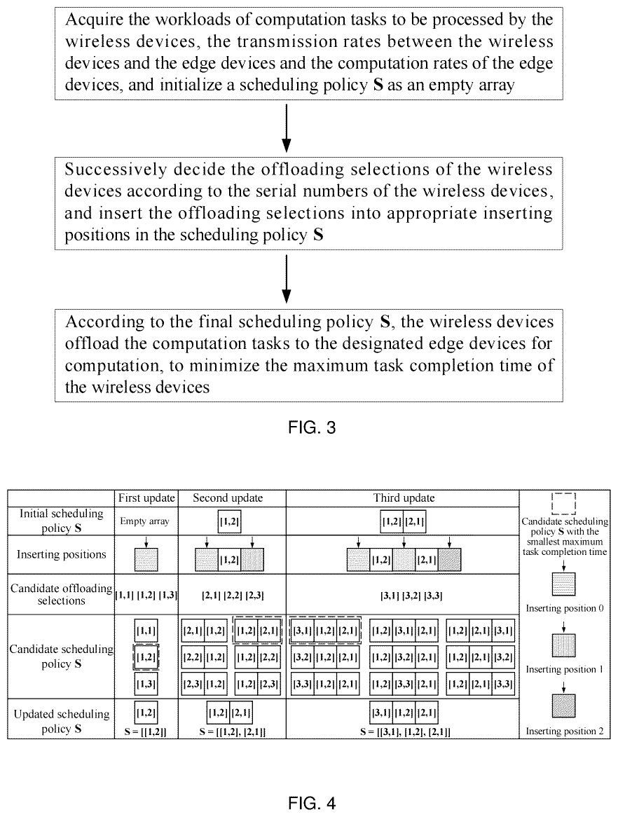

As shown in FIG. 3, the task scheduling method for a multi-edge device assisted edge computing network includes the following steps.

In step 1, the workloads of computation tasks to be processed by the wireless devices, the transmission rates between the wireless devices and the edge devices and the computation rates of the edge devices are acquired, and a scheduling policy S is initialized as an empty array.

In step 2, the offloading selections of the wireless devices are successively decided according to the serial numbers of the wireless devices, and the offloading selections are inserted into appropriate inserting positions in the scheduling policy S.

As shown in FIG. 4, this example will be described by taking a multi-edge device assisted edge computing network composed of three edge devices and three wireless devices as an example. During the first update of the scheduling policy S, the transmission delays of the first wireless device offloading the computation task to different edge devices and the computation delays of different edge devices computing the received computation task of the first wireless device are calculated according to the information obtained in step 1.

For the first wireless device, there are total three candidate offloading selections, i.e., [1,1], [1,2] and [1,3]. During the first update of the scheduling policy S, the initial scheduling policy S is an empty array. Without changing the relative positions of the existing offloading selections in the scheduling policy S, there are one inserting position.

The candidate offloading selections of the first wireless device are inserted into the inserting position in the scheduling policy S respectively to obtain three candidate scheduling policies S, i.e., [[1,1]], [[1,2]] and [[1,3]], and the corresponding maximum task completion times are calculated.

Among the three candidate scheduling policies S, the candidate scheduling policy S=[[1,1]] has the smallest maximum task completion time, so that the scheduling policy is updated as S=[[1,1]].

During the second update of the scheduling policy S, the transmission delays of the second wireless device offloading the computation task to different edge devices and the computation delays of different edge devices computing the received computation task of the second wireless device are calculated according to the information obtained in step 1.

For the second wireless device, there are total three candidate offloading selections, i.e., [2,1], [2,2] and [2,3]. During the second update of the scheduling policy S, the initial scheduling policy S is S=[[1,1]]. Without changing the relative position of the existing offloading selections in the scheduling policy S, there are two inserting positions.

The candidate offloading selections of the second wireless device are inserted into the inserting positions in the scheduling policy S respectively to obtain six candidate scheduling policies S, i.e., [[2,1],[1,2]], [[1,2],[2,1]], [[2,2],[1,2]], [[1,2],[2,2]], [[2,3],[1,2]] and [[1,2],[2,3]], and the corresponding maximum task completion times are calculated.

Among the six candidate scheduling policies S, the candidate scheduling policy S=[[1,2],[2,1]] has the smallest maximum task completion time, so that the scheduling policy is updated as S=[[1,2],[2,1]].

For the third wireless device, the process of updating the scheduling policy S is similar to the process of updating the scheduling policy S with regard to the first and second wireless devices.

Further, in step 2, the scheduling policy S=[ . . . , [i, j], . . . ] contains the offloading selections of the wireless devices and the scheduling order of task offloading of corresponding computation tasks, where the offloading selection [i, j] of the wireless device represents that the i^{th} wireless device offloads the computation task to the j^{th} edge device for computation, and the order of the offloading selections of the wireless devices in the scheduling policy S represents the scheduling order of task offloading of corresponding computation tasks.

Furthermore, in step 2, the transmission delay of the i^{th} wireless device offloading the computation task to the j^{th} edge device is:

$${t}_{i , j} = \frac{{w}_{i}}{{r}_{i , j}}$$

where wᵢ is the workload of the computation task of the h wireless device, and r_{i,j} is the transmission rate between the i^{th} wireless device and the j^{th} edge device.

The computation delay of the j^{th} edge device computing the received computation task of the i^{th} wireless device is:

$${c}_{i , j} = \frac{{w}_{i}}{{f}_{j}}$$

where fⱼ is the computation rate of the j^{th} edge device.

In step 3, according to the final scheduling policy S, the wireless devices offload the computation tasks to the designated edge devices for computation in sequence, to minimize the maximum task completion time of the wireless devices.

The scheme in this embodiment realizes a smaller maximum task completion time of the wireless devices.

The contents described in the embodiments of this specification are only the examples of the implementation forms of the inventive concept, and are only used for illustrative purposes. The protection scope of the present invention should not be regarded as being only limited to the specific forms stated in this embodiment, and is also extended to the equivalent technical means that can be conceived by a person of ordinary skill in the art according to the inventive concept.

1. A task scheduling method for a multi-edge device assisted edge computing network, wherein the multi-edge device assisted edge computing network comprises M edge devices and N wireless devices, wherein the edge devices are connected to the wireless devices through wireless links, and the edge devices can provide computing services for the wireless devices; every wireless device owns an indivisible computation task to be processed, does not have enough computational capacity to process it locally, and has to offload it to one of the edge devices for computation in a time division multiple access manner; every edge device can compute the computation task only after it has received the whole computation task; every edge device is allowed to receive one computation task and compute another computation task simultaneously, every edge device can only compute at most one computation task at any time, and different edge devices can compute their respectively received computation tasks simultaneously; in order to realize a smaller maximum task completion time, the wireless devices continuously offload computation tasks to the edge devices in a time division multiple access manner until all the wireless devices have offloaded computation tasks, and the edge devices can stop the computation operation only when there are no received computation tasks can be computed; and, the task scheduling method for an edge computing network comprises the following steps:
step 1: acquiring the workloads of computation tasks to be processed by the wireless devices, the transmission rates between the wireless devices and the edge devices and the computation rates of the edge devices, and initializing a scheduling policy S as an empty array;
step 2: successively deciding the offloading selections of the wireless devices according to the serial numbers of the wireless devices, and inserting the offloading selections into appropriate inserting positions in the scheduling policy S; and
step 3: offloading the computation tasks, according to the final scheduling policy S and by the wireless devices, to the designated edge devices for computation, to minimize the maximum task completion time of the wireless devices.

2. The task scheduling method for a multi-edge device assisted edge computing network according to claim 1, wherein, in step 2, the scheduling policy S=[ . . . , [i, j], . . . ] contains the offloading selections of the wireless devices and the scheduling order of task offloading of corresponding computation tasks, where the offloading selection [i, j] of the wireless device represents that the i^{th} wireless device offloads the computation task to the j^{th} edge device for computation, and the order of the offloading selections of the wireless devices in the scheduling policy S represents the scheduling order of task offloading of corresponding computation tasks.

3. The task scheduling method for a multi-edge device assisted edge computing network according to claim 1, wherein, in step 2, in order to decide the offloading selection of the i^{th} wireless device, the transmission delays of the i^{th} wireless device offloading the computation task to different edge devices and the computation delays of different edge devices computing the received computation task of the i^{th} wireless device are calculated according to the information obtained in step 1; without changing the relative positions of the existing offloading selections in the scheduling policy S, i candidate scheduling policies S are generated for every candidate offloading selection of the i^{th} wireless device, and the corresponding maximum task completion times are calculated; as the number of candidate offloading selections of i^{th} wireless device is M, Mi candidate scheduling policies S are generated in total for the i^{th} wireless device, and the candidate scheduling policy S with the smallest maximum task completion time is selected and updated as a new scheduling policy S;
the transmission delay of the i^{th} wireless device offloading the computation task to the j^{th} edge device is:
$${t}_{i , j} = \frac{{w}_{i}}{{r}_{i , j}}$$
where wᵢ is the workload of the computation task of the i^{th} wireless device, and r_{i,j} is the transmission rate between the i^{th} wireless device and the j^{th} edge device;
the computation delay of the j^{th} edge device computing the received computation task of the i^{th} wireless device is:
$${c}_{i , j} = \frac{{w}_{i}}{{f}_{j}}$$
where fⱼ is the computation rate of the j^{th} edge device.
